(19) United States
(12) Patent Application Publication
(10) Pub. No.: US 2011/0043496 A1
(43) Pub. Date: Feb. 24, 2011

(54) DISPLAY DEVICE

(76) Inventor: Bianca R. RAY AVALANI, San Diego, CA (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/850,659

(22) Filed: Aug. 5, 2010

Related U.S. Application Data
(60) Provisional application No. 61/236,386, filed on Aug. 24, 2009.

(51) Int. Cl. G09G 5/00

(52) U.S. Cl. 345/204

(57) ABSTRACT

A glove having a display device is described. The glove comprises a glove; a display device connected with the glove, the display device comprising: a controller; a display coupled with the controller; and an input/output device coupled with the controller and arranged to be coupled with a wireless camera; and wherein the controller is arranged to receive an image from the I/O device and cause the display to display the received image. In alternate embodiments, the glove is a wristband or other user-wearable garment. In still further alternate embodiments, the display device may be carried directly by a user without use of a garment. In alternate embodiments, the glove is a wristband or other user-wearable garment. In still further alternate embodiments, the display device may be carried directly by a user without use of a garment. The display device (or a matched pair of display devices) with or without the glove or wrist-band (or a matched pair of gloves or pair of wrist-bands) may also be an integral part of a vehicular system.

### BACKGROUND

Gloves or wrist-bands may be worn for a number of purposes including for warmth, cleanliness, safety, and as a fashion accessory. Prior known functional gloves have included lights for illumination and identification purposes. Functional gloves have also included pockets for heating elements and other heating mechanisms to warm a user's hands inserted in the glove.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a view of a wearable display device in the form of a glove according to an embodiment;

FIG. 2 is a high-level block diagram of a wearable display device system according to an embodiment;

FIG. 3 is a high-level block diagram of a wearable display device system according to another embodiment;

FIG. 4 is a high-level functional block diagram of a wearable display device according to an embodiment;

FIG. 5 is a view of a wearable display device in the form of a wristband according to an embodiment;

FIG. 6 is a view of a user wearing a glove according to an embodiment; and

FIG. 7 is a view of a user carrying a system comprising a display device according to an embodiment;

FIG. 8 is a view of a user wearing a pair of wristbands according to an embodiment;

FIG. 9 is a high-level functional block diagram of an augmented reality (AR) functionality based wearable display device according to an embodiment;

FIG. 10 is a high-level functional process flow diagram of at least a portion of operation of an augmented reality based method;

FIG. 11 is a high-level block diagram of components of a wireless wearable display device according to an embodiment; and

FIG. 12 is a high-level functional block diagram of at least a portion of a wearable display device according to another embodiment.

### DETAILED DESCRIPTION

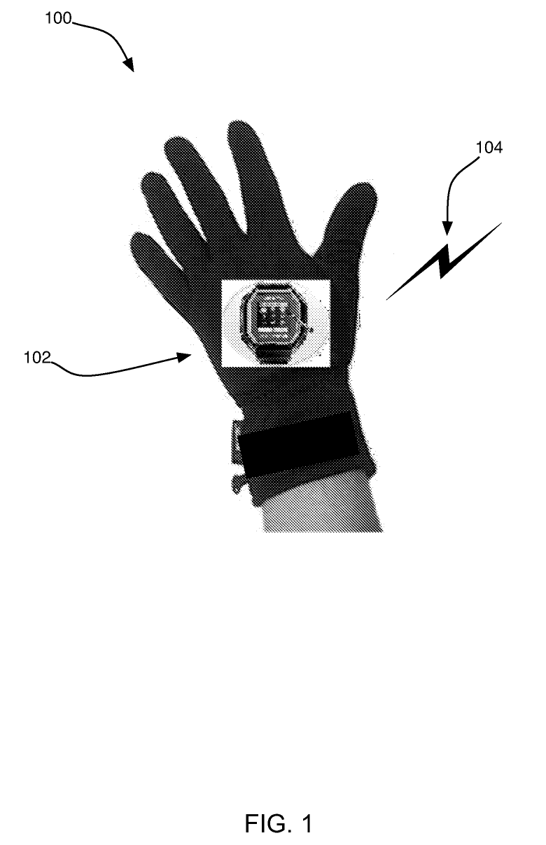

FIG. 1 depicts a view of a wearable display device in the form of a glove 100 according to an embodiment. In at least some embodiments, glove 100 comprises one or more fingers for receiving a user's fingers therein. In at least some embodiments, glove 100 comprises one or more partial fingers, e.g., fingers which are open at the end or fingertip region to enable a user to directly contact an item. In at least some embodiments, glove 100 does not comprise any fingers and instead forms a mitten or a wristband.

Glove 100 also comprises a display device 102 coupled to a portion of the glove. Display device 102 is integrated as a part of glove 100, e.g., the display device components are woven, stitched, bonded, or otherwise integrally formed or constructed as a part of the glove. In at least some embodiments, display device 102 is separately mounted or attached to glove 100, e.g., via glue, stitching, hook and loop fasteners, or other mounting mechanisms. In at least some embodiments, display device 102 is permanently affixed to glove 100 and, in at least some other embodiments, the display device is removably attached to the glove. Non-limiting, exemplary removable attachment mechanisms comprise hook and loop fastener strips, suction cups, a display holder, or similar mechanisms.

In particular, display device 102 is connected to an outside, back-of-hand portion of glove 100. Display device 102 is attached proximate the base of the user's fingers. In at least some embodiments, display device 102 may be attached distal from the user's fingers, e.g., closer to the wrist or arm region. In at least some other embodiments, display device 102 is connected to an inside portion of glove 100, e.g., in or below the palm region. In at least some further embodiments, display device 102 is connected to a portion of glove 100 adjacent an opening of the glove.

Display device 102 is positioned on glove 100 in such a manner to enable a user to view a display of the display device during normal operations of the user, e.g., while driving, skiing, sitting, manipulating tools, etc. Alternatively, display device 102 is positioned on glove 100 such that the display is viewable by the user with a rotation of the arm, wrist, or hand.

In at least some embodiments, display device 102 comprises a wireless receiver mechanism for receiving a transmission 104 comprising information and/or one or more images from a camera. In at least some embodiments, the wireless receiver mechanism comprises a BLUETOOTH receiver, a WiFi receiver, a GPS receiver, a satellite radio receiver or another form special-purpose wireless receiver mechanism (for example a FlashlinQ receiver, e.g., FLASHlinQ available from Qualcomm, Inc.). In at least some embodiments, the wireless receiver comprises an infrared receiver.

In at least some other embodiments, display device 102 comprises a wired connection mechanism for receiving transmission 104. For example, display device 102 is connectable to a data cable for receiving transmission 104.

Transmission 104 comprises a local and/or a remote or wide area transmission, e.g., the transmission may originate from a source within a few feet of device 100 or in other cases from a source within hundreds or thousands of meters. In at least some embodiments, transmission 104 originates from a device within range of device 100. In at least some other embodiments, transmission 104 originates from a device beyond the range of device 100 via at least one network connection intermediary.

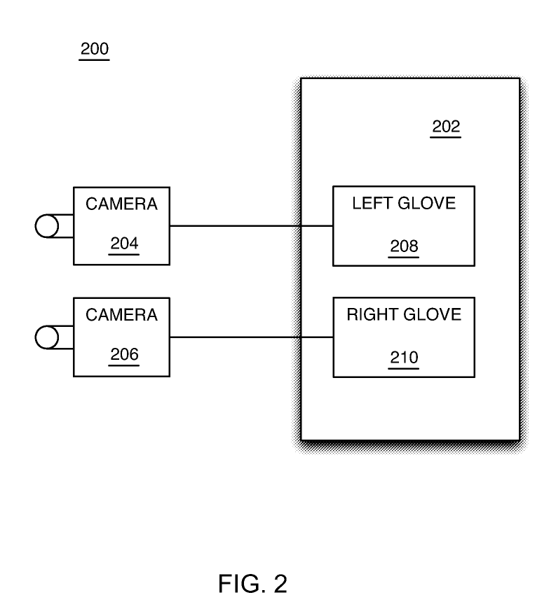

FIG. 2 depicts a high-level block diagram of a wearable display device in the form of a glove system 200 comprising a pair of gloves 202 (e.g., as depicted and described with respect to FIG. 1) according to an embodiment using BLUETOOTH as the wireless communication mechanism to communicate with a pair of wireless cameras 204, 206. Pair of gloves 202 comprises a first glove 208, e.g., a left-hand glove, and a second glove 210, e.g. a right-hand glove. In at least some other embodiments, the camera and glove communication may be performed using one or more of different communication protocols, e.g., WiFi, WiMax, InfraRed, etc.

First (left) glove 208 has been paired (connected in a pairing of wireless communication devices such that each device recognizes the other and receives/transmits information to the other) with a first camera 204, e.g. a camera mounted on a left-hand side of a vehicle in which a user wearing the pair of gloves 202 is/will be traveling. Similarly, second (right) glove 210 has been paired with second camera 206, e.g., a camera mounted on a right-hand side of the vehicle. In this manner, each camera 204, 206 transmits live images and/or video to a corresponding one of the pair of gloves 202. In at least some embodiments, data and/or information other than image or video may be transmitted between the remote device, e.g., camera 204, and wearable display device 100, such as audio or other sensing data, e.g., temperature, humidity, wind speed, etc., depending on the particular remote device.

In at least some embodiments, camera to glove pairing may be performed in a different manner, either predetermined or via a user determination. In some instances, the cameras may each be paired with a glove on an opposite hand, e.g., a left-hand camera paired with a right hand glove.

In some instances, both cameras may be paired with a single glove. In such instances, the single glove may display both images/videos from the cameras or the single glove may transfer the information received from one of the cameras to the other glove for display.

1. A pair of gloves (wrist-bands or other wearable items) that store, display and communicate particular information for particular situations to the user.

2. The pair of gloves (or in some embodiments a pair of wristbands) display information to the user just like a book (with a left page and right page), something that the user is used to seeing in real life. Also, since it involves a pair of displays, it allows the user to look at a large document such as a map or a blueprint of a design (by putting the two gloves next to each other).

3. It is much easier for the user to look at two displays mounted on the back of a pair of gloves (than in sneakers, headbands, or T-Shirts that he might be wearing).

4. It is easier for the driver of a car (or the pilot of an airplane) to use these displays as “auxiliary displays” for necessary information while driving or flying (while keeping both hands on the steering wheel).

5. For a driver, the display on the left glove can display the information from the left side-view mirror and the right glove can display information from the right side-view mirror of a car. As a result, a race car driver views the images on the two side-view mirrors almost simultaneously without even moving his head, while still driving the car at a high speed with both hands on the steering wheel (the live video-images in this case are transmitted from a camera mounted on the external side-view mirrors of the car to the displays on the gloves through, for example, a wireless connection such as BLUETOOTH or WIFI).

6. As mentioned before, the information is also displayed automatically at pre-selected times based on the physical location of the user. Such time-based, location-based or context-based information is useful to hikers, skiers, doctors, police officers and firemen. For example, the location and/or type of dangers within a vicinity of the wearer may be displayed to an outdoor person or an emergency responder. In at least some embodiments, imminent drop-offs or explosive materials, etc. are displayed to the wearer.

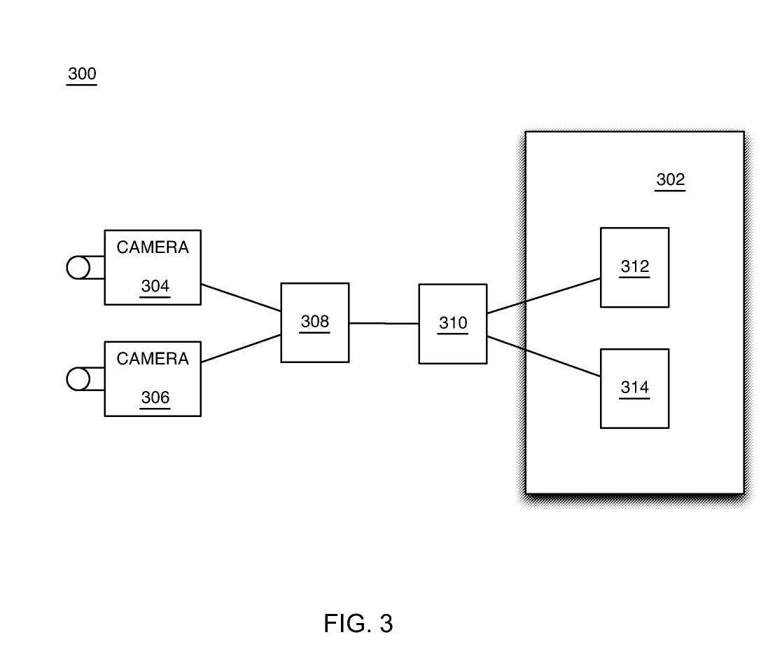

For at least a vehicle-based embodiment, the input mechanism comprises 2 BLUETOOTH based cameras, e.g., webcams or other similar wireless transmitting (and in some embodiments, receiving) cameras, each positioned just above the side-view mirror of the vehicle, e.g., a car. In at least some embodiments, the wireless cameras replace the side-view mirrors and thereby reduce overall vehicle weight and improve vehicle aerodynamics. Each camera communicates with components of the corresponding glove to enable the display of an image on the display attached to the glove. In at least some embodiments, the display comprises a BLUETOOTH receiver capable of receiving video signals (an alternative implementation uses WI-FI instead of BLUETOOTH, e.g., see FIG. 3).

In another embodiment, the display itself is worn like a wrist-watch (with two straps with hook and loop fastener pads, e.g., VELCRO-like pads, attached to the two sides of the display) or a removable patch or a removable adhesive material, e.g., similar to a band-aid, on the back-side of the user's hand.

In at least some embodiments, the display is of a size 1″×2″ or larger with sufficient resolution for viewing by a user. In at least some embodiments, the display is a light emitting diode (LED) based display, an organic LED based display or another type display. In at least some embodiments, the display is color or black and white.

In at least some embodiments, the display is a touch-control (touch-based) display (or voice controlled display) capable of operating with touch or gesture-based input (or voice based input) from the user. In at least some embodiments, one or both of the gloves 208, 210 comprise one or more accelerometers and/or other sensors such as a gyroscope to enable gesture-based input in the form of a user hand movement.

In at least some embodiments, touch or gesture-based input from the user received by one or both of the gloves may be translated into one or more commands for transmission to a camera or to the other glove. In at least some embodiments, the commands cause the camera to pan, tilt, zoom, or perform other functions. In at least some embodiments, the input received from the user also comprises speech-based input.

One or more embodiments of the design of a pair of gloves includes one or more of the following built-in components:

a global positioning system (GPS) device, e.g., in the form of an integrated circuit chip;

a camera;

a memory or storage medium, e.g., an SD-card;

a communication system, including a modem, e.g., in some embodiments, the communication system is capable of receiving SMS or other messages;

an information storage or retrieval module; and

sensors such as, accelerometers (or a medical device, e.g., a temperature, blood pressure, heart rate or other monitor);

a small FM radio or a miniature TV (similar to or including FLO TV);

a display with or without a keyboard;

a central processing unit (CPU) and/or an application processor;

a microphone and/or a speaker unit;

an antenna;

Bluetooth, WIMAX or WI/FI receivers.

The gloves (or wrist-bands) are worn by kids, athletes, various other sports enthusiasts like skiers or hikers, machinists, handymen, police officers, military personnel or even by medical professionals, such as doctors, surgeons or nurses during active duty. The overall system is capable of tracking the location of the person wearing the gloves and generating a signal, e.g., a sound or other alert to the wearer or transmitting a signal to others (including rescuers) in case the person veers beyond an acceptable range. For example, parents or coaches can remotely monitor the location of a kid or a skier wearing the gloves. If he/she wanders off into a region where he or she is not supposed to enter, the system transmits a signal (alert in the form of a beep, vibration, SMS, e-mail etc.) to the parents.

In case of an accident, for example, if the skier is buried in snow due to blizzard conditions, or during a fire or an earthquake, the displays may sense the ambient condition (through sensors) and the system may continue to transmit the location information to the rescuers (like a black-box of an airplane). Essentially, the glove system is a life-saving device to people whose lives might be in danger due to accidents or circumstances beyond their control.

The gloves (or wrist-bands) are also capable of displaying important information to the person wearing them. For example, a skier displays his or her entire skiing route on a map shown on the display and pin-points his exact location with a red circle, so he is fully aware of his location and his surroundings in real-time (or able to detect the proximity of other skiers in the surrounding areas).

In another embodiment, a doctor stores critical information about a surgery into the information module (e.g., a memory such as an SD card) of the gloves, including what to do in case of a serious emergency before starting an operation. During the surgery, the doctor retrieves the information quickly just by touching the display or use of a verbal command.

In another embodiment, a coal-miner or a soldier during war accesses vital information about an exit route or a military maneuver by touching the embedded display unit attached to the pair of gloves.

Under normal conditions, the entire electronics module including the display is mounted on the flat part of the gloves (e.g., on the back of the hand opposite the palm), so the image is easily viewable by the user, video and texts on the display are visible even while conducting normal operations/activities such as skiing, hiking or flying.

The overall unit is also usable in a stealth mode. In this mode of operation, the electronics module comprising the wearable display device including the GPS chip, a camera and the display is mounted within the gloves with or without the knowledge of the wearer (so that the device is not readily visible to the user). Under normal conditions, the unit does not transmit a signal. Responsive to receipt of a remote signal, e.g., a short message system (SMS) message, the device is surreptitiously activated. After activation, the device begins transmitting the current determined GPS coordinates of the device, surrounding images (e.g., obtained via a connected camera) and ambient noise in the room (including conversations, etc. via an included or connected microphone) where the wearer is located. In at least some embodiments, the microphone is a component of the device while in some other embodiments, the microphone is wirelessly connected to the device. Once the device in the gloves starts communicating with a remote device, i.e., transmitting obtained information and sensed parameters, further information (or instructions) are transmissible to the wearer of the gloves on an as-needed basis. This mechanism is useful for tracking a lost or kidnapped child, for example.

FIG. 3 depicts a high-level block diagram of a wearable display device in the form of a glove system 300 (similar to glove system 200) comprising a pair of gloves 302 according to an embodiment using a wireless network-based communication mechanism, e.g., a WiFi or WiMax or other wireless network, to communicate with a pair of wireless cameras 304, 306.

Each of wireless cameras 304, 306 communicates with a wireless router 308 which, in turn, is connected with a processor or controller-based device 310. In at least some embodiments, router 308 is wirelessly and/or wired connected with device 310. Controller-based device 310 is in wireless communication with each of gloves in the pair 302. In at least some embodiments, router 308 and controller-based device 310 may be combined into a single device. In at least some other embodiments, controller-based device 310 may be integrated into gloves 302, e.g., integrated into one or the other of gloves 312, 314.

Pair of gloves 302 comprises a first glove 312 and a second glove 314. In at least some embodiments, controller-based device 310 receives communications from one or the other of wireless cameras 304, 306 and based on one or more predetermined settings transfers the communication to one or both of gloves 312, 314, as appropriate.

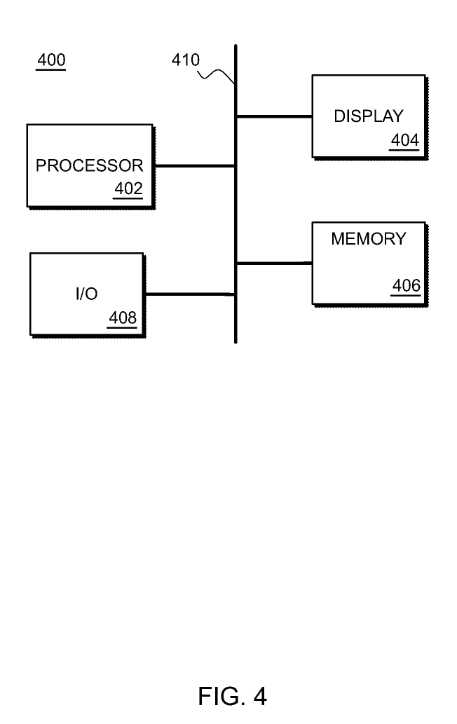

FIG. 4 depicts a high-level functional block diagram of an embodiment of a wearable display device 400 usable as display device 102 (FIG. 1). Display device 400 comprises a processing device (or controller or processor) 402, a display 404, a memory 406, and an input/output (I/O) device 408 each communicatively coupled with a bus 410. Memory 406 (also referred to as a computer-readable medium) is coupled to bus 410 for storing data and information, e.g., instructions, to be executed by processing device 402. Memory 406 also may be used for storing temporary variables or other intermediate information during execution of instructions to be executed by processing device 402. Memory 406 may also comprise a read only memory (ROM) or other static storage device coupled to bus 410 for storing static information and instructions for processing device 402. Memory may comprise static and/or dynamic devices for storage, e.g., optical, magnetic, and/or electronic media and/or a combination thereof.

Display device 404 may comprise an input device, an output device, and/or a combined input/output device for enabling interaction with processing device 402. For example, display device 404 may comprise a user input device such as a keyboard, keypad, mouse, trackball, microphone, scanner, or other input mechanism, and/or an output device such as a display, speakers, or other output mechanism. Additionally, display device 404 may comprise an input and/or an output connection for interacting with one or more sensors, e.g., a light sensor, a temperature sensor, a humidity sensor, a heart rate monitor, a motion sensor, a global positioning system (GPS) receiver, etc.

I/O device 408 comprises a mechanism for connecting to a network. In at least some embodiments, I/O device 408 may comprise a wired and/or wireless connection mechanism. In at least some embodiments, processing device 402 may communicate with another processing device, e.g., a computer system, via I/O device 408. In at least some embodiments, display device 400 may communicate with another display device via I/O device 408, i.e. a left-hand glove may communicate with a right-hand glove. In this manner, two or more gloves according to the above embodiment may communicate to transfer data and/or control commands between themselves and/or to/from one or both of the cameras. In at least some embodiments, I/O device 408 comprises an antenna for wireless communication with other devices, e.g., wireless cameras 304 and/or 306. In at least some alternate embodiments, display device 400 may comprise a separate antenna for wireless transmission and reception of data and/or commands.

I/O device 408 comprises a serial and/or a parallel communication mechanism. Non-limiting, exemplary embodiments of I/O device 408 include at least a wireless Universal Serial Bus (USB) interface, an Ethernet interface, a WiFi or WiMax or BLUETOOTH interface, a cellular interface, etc.

In at least some embodiments, display device 400 is configured to display local or remote information to a user via display 404. The local or remote information may comprise one or more of textual, video, image, or other information. In at least some embodiments, the local or remote information may comprise static information, such as the display of maps for navigation, or dynamic information, such as video captured from a camera.

In at least some embodiments, one of a pair of gloves 202 may be configured to receive and display on display device 400 remote information comprising global positioning system information, i.e., map data, and/or traffic information received via a wireless communication mechanism. For example, an additional Bluetooth connection may be made between a glove, e.g., left glove 208, and a personal communication device such as a cell phone of the user in order to obtain GPS and or traffic information for display.

In at least some other embodiments, the remote information received and displayed on display device 400 may comprise video and/or images or other information received from further remote devices. For example, in at least one embodiment, video may be wirelessly received from a backup camera installed in the rear of a vehicle being driven by the user. Additionally in some embodiments, other information detected or determined by a backup system which may include a backup camera is also be displayed and/or conveyed to the user wearing the gloves, e.g., a distance remaining until impact with an object is displayed on one or the other or both of the gloves.

In at least some embodiments, display devices on the gloves may be connected to one or more cameras focused on blind spots (blind zones) of the driver of the vehicle. In accordance with this embodiment, the gloves connected to the cameras would provide new, additional information beyond that provided by side view mirrors.

In at least some other embodiments, display devices on the gloves may be connectable to additional cameras focused on an interior of the vehicle. For example, in at least one embodiment, a camera is directed toward a rear seat of the vehicle for a parent to keep an eye on a child or a taxi driver to view riders.

In another example embodiment, video and/or images may be received from a remote monitoring camera, e.g., a “nanny” cam installed in the user's home. In this manner, the gloves may provide a display of current happenings at the user's home. The information displayed on the display device may be received via a wireless network connection of the gloves or a personal communication device of the user, e.g., either of which connected to an internet or the packet switched network referred to as the Internet.

In at least some embodiments, one of a pair of gloves 202 may be configured to receive and display on display device 400 local information comprising video, images, textual or other information stored in a storage medium of the pair of gloves. For example, written driving instructions, lists of information, images of landmarks along a route, or other information stored in one of the gloves may be accessed and displayed to the user.

In at least one embodiment, the display device may be an e-reader capable of receiving, in either wired or wireless manner, and displaying some form of documentation or manuals.

In at least one embodiment, the display device may be similar to an electronic notepad, e.g., an IPAD, on which a doctor writes a quick prescription for a patient and wirelessly transmits the prescription to a pharmacy while the doctor is stuck in a traffic jam while driving during rush-hour.

In at least some embodiments, wearable display device 400 also comprises one or more speakers and/or a microphone for the generation and/or capture of audio information at the wearable display device.

In at least some embodiments, a display device, e.g., display device 404 (FIG. 4), may be mounted to a wristband for wearing by a user.

In at least some embodiments, one or more components of wearable display device 400 are integrated into a single unit, e.g., glove 202. In at least some alternative embodiments, one or more components of wearable display device 400 comprise one or more separate units in communication with each other, e.g., one or more wired/wireless connections replacing all or part of bus 410. In a given embodiment, one or more components of wearable display device 400 communicate in a machine-to-machine manner. For example, a connection to a central wireless access point, e.g., a hub or router, need not be established in order for the components to communicate.

In at least some embodiments, wearable display device 400 comprises a portable electronic device, e.g., a cellular or portable telephone, a personal digital assistant, etc., providing at least a portion of the functionality, display, and/or processing of the wearable device.

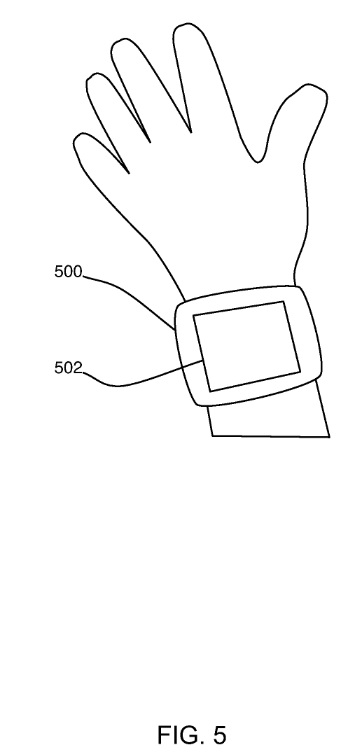

FIG. 5 depicts a view of a wristband 500 comprising a display device 502. In at least some embodiments, wristband 500 comprises a flexible or inflexible material for gripping by the user or for retaining the display device on the user's hand/wrist.

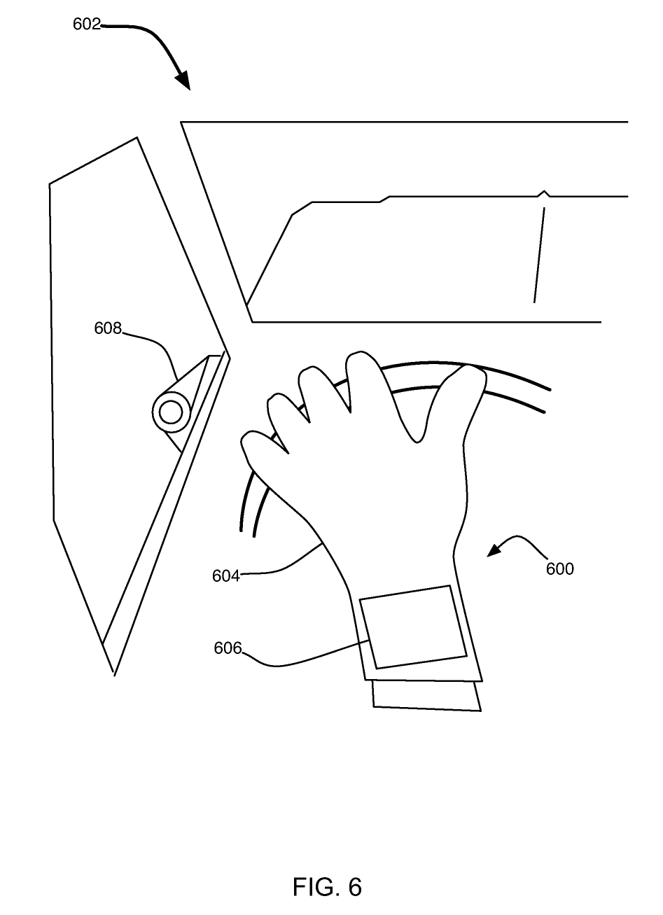

FIG. 6 is a view of a user 600 in a vehicle 602 and wearing a glove 604 having a wearable display device 606 according to one of the foregoing embodiments. A wireless camera 608 in communication with display device 606 is visible and wirelessly transmits images and/or video to the display device for viewing by the user.

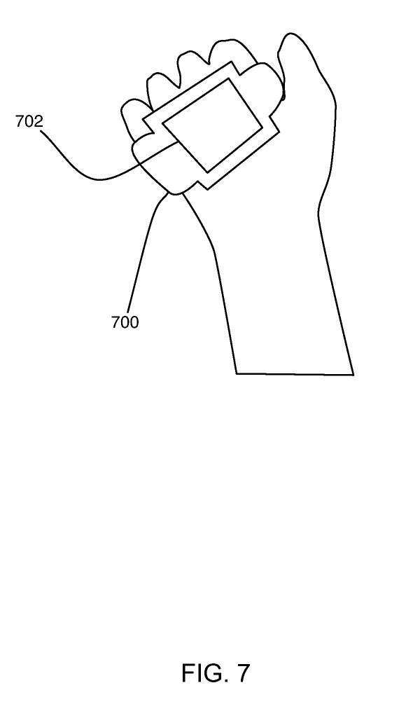

FIG. 7 depicts a view of a user carrying, with a holding strap within a clenched fist of the user, a system 700 having a display device 702, according to one of the foregoing embodiments, attached thereto. In at least one embodiment, display device 702 is similar to display device 400 (FIG. 4). In at least some embodiments, the system comprising the display device need not be attached to a garment, e.g., a glove or wristband, to be usable by a user.

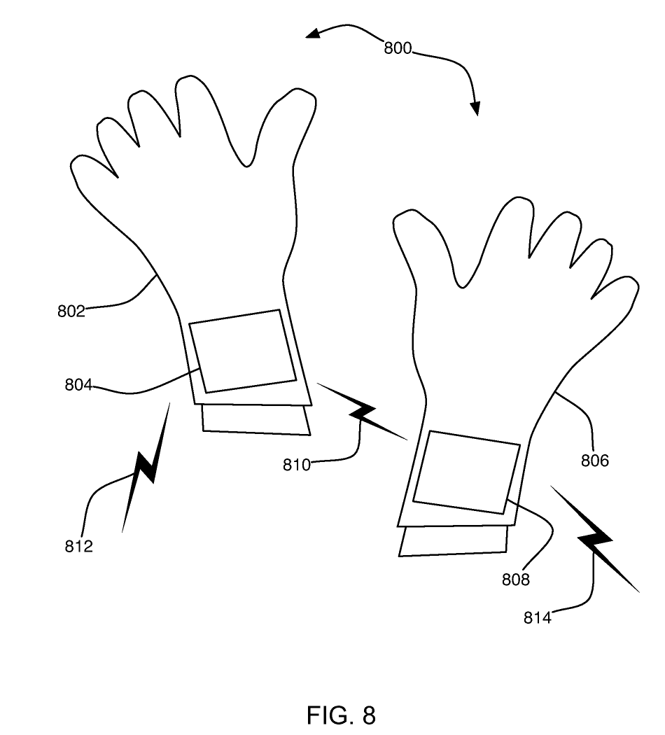

FIG. 8 is a view of a user wearing a pair of wearable display devices in the form of a pair of gloves 800, i.e., a left hand glove 802 having an attached wearable display device 804 and a right hand glove 806 having an attached wearable display device 808. Also depicted in FIG. 8 are communication signals transmitted between the pair of gloves and to/from each of the gloves, i.e., an inter-glove transmission 810 and a pair of transmissions 812, 814 to each of respective gloves 802, 806. In at least some embodiments, inter-glove transmission comprises at least one of commands, images, video, audio, or other information (e.g., sensor information received by the other glove) from one of the gloves 802, 806. In at least some embodiments, a user inputs a command to one or both of the gloves based on a motion of one or both of the gloves.

In at least some embodiments, the user enters a command input based on a relationship and/or orientation of the gloves with respect to each other. For example, in at least some embodiments, different commands may be input to the display device 804 based on the user overlaying one hand-wearing glove atop the other hand-wearing glove in a stacking arrangement. In at least some other embodiments, the proximity of the gloves to each other determines a particular command to be input to the display device of one or both of the gloves. In at least some other embodiments, a motion of one or both of the gloves with respect to the other serves to cause the generation and input of a command to one or both of the display devices 804, 808. For example, the user may rapidly move the gloves away from each other in order to cause the entry of a zoom out command, etc.

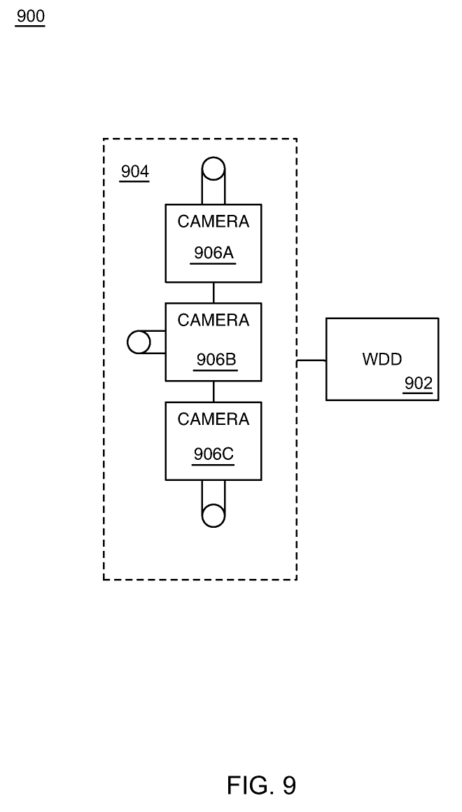

FIG. 9 is a high-level functional block diagram of an augmented reality (AR) functionality based wearable display device 900 according to an exemplary embodiment combining a wearable display device 902 and a camera arrangement 904 comprising three wireless cameras 906A-C. In at least some embodiments, wireless cameras 906A-C are communicatively connected with each other, to a central controller, or to a primary one of the cameras via a wired and/or a wireless connection. Camera arrangement 904 is communicatively connected with wearable display device 902 via a wired and/or a wireless connection.

In a given embodiment, wireless cameras 906A-C are replacements for, or in addition to, an existing side view mirror on a vehicle, i.e., in at least some embodiments, a camera arrangement replaces one side view mirror and another camera arrangement replaces another side view mirror. In the given embodiment, each camera is positioned to capture an image at right angle to at least one other camera. In the given embodiment, camera 906A faces forward, camera 906B faces sideways away from the vehicle, and camera 906C faces backward in typical side view mirror fashion. Camera arrangement 904 forms a “T” shaped junction of cameras.

In at least one embodiment, images and/or video captured by the camera arrangement 904 are presented on a corresponding wearable display device 902, e.g., if the camera arrangement is on the left side of the vehicle, then the captured video is displayed on a wearable display device worn on the user's left hand or correspondingly if the camera arrangement is on the right side of the vehicle, then the captured video is displayed on a wearable display device worn on the user's right hand. In at least some embodiments, the video may be directly displayed on the display device as received from the camera arrangement. In at least some other embodiments, the video from the camera arrangement is subjected to pre-processing prior to display on the wearable display device. In at least one embodiment, contrast enhancement may be performed on the video. In at least another embodiment, pre-processing of the video includes selectively arranging the display position of the video on the display device, e.g. displaying one image at a top portion of the display, one image at the middle of the display, and one at the bottom, and/or integrating corresponding text messages/alert messages, for example, based on augmented reality input.

In a given embodiment, the combination camera arrangement 904 and wearable display device 902 operate as an automated tour guide system for the driver of the vehicle. In at least some embodiments, such a system may further comprise integration of a positioning system, e.g., a GPS-based device. A non-limiting example of operation of such a given embodiment comprises a user driving through a city and receiving alerts from wearable display device 902 based on, for example, image-based recognition using images from camera arrangement 904. For example, arriving in Washington, D.C., the system may provide an alert such as “You are now approaching Chinatown ahead; the Washington Monument is behind you; and the White House is on your left.” After arriving at a destination, the user may continue using wearable display device 902 upon exiting the vehicle. In at least one embodiment, images received from a portable camera, e.g., a cell phone camera, may be used by wearable display device 902 to continue to provide navigational guidance and an augmented reality-based virtual tour guide along the users path. In at least one embodiment, wearable display device 902 may be removed from a glove to which it was affixed and attached to a wristband, and armband, a belt, or another mechanism for carrying by the user. In at least some embodiments, wearable display device 902 may be carried directly in the hand of the user.

In at least some embodiments, each camera arrangement 904 may comprise a single camera 906.

In another given embodiment, camera arrangement 904 and wearable display device 902 operate to provide augmented reality based on image recognition applied to video and/or images from the wireless camera. In operation, processor 402 (FIG. 4) executes instructions of an augmented reality application stored in memory 406 two, based on the received images, to recognize at least some of the content in the images against comparison against images in a database, e.g., stored in memory 406 or accessible via a network connection. Responsive to particular image recognition, alerts in the form of audible, visible, or other haptic feedback may be provided to the user. For example in a given scenario, a warning such as, “you have a police car approaching you from behind” or “there is a Chevy Malibu directly in your blind zone on the right side of your vehicle” may be provided to the driver of the vehicle.

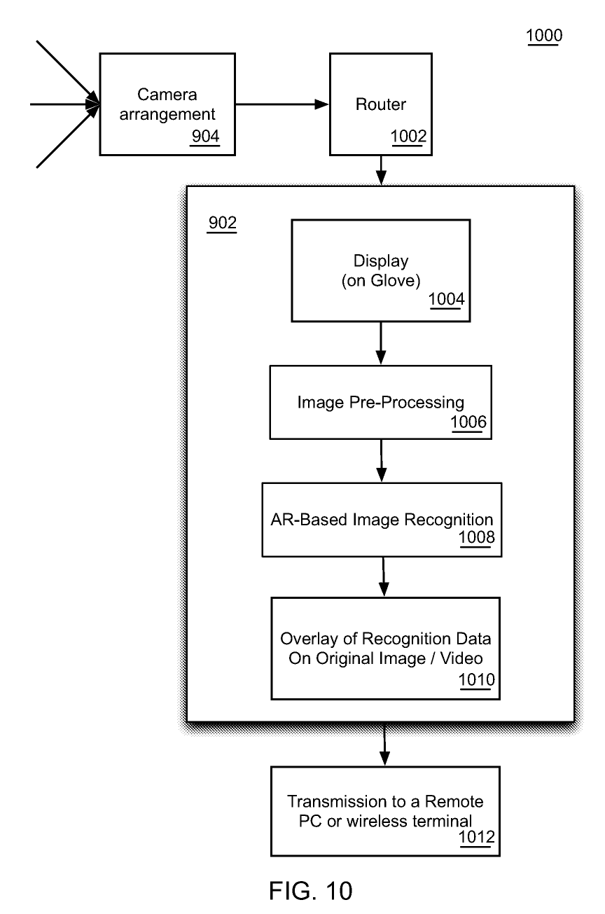

FIG. 10 is a high-level functional process flow diagram of at least a portion of operation of an augmented reality based method 1000 of using wearable display device 902 (FIG. 9) in accordance with at least one embodiment. The process flow begins with camera arrangement 904 (comprising one or more wireless cameras as described above) viewing a scene in a particular direction, e.g., forward facing, backward facing, and an orthogonal direction thereto. Camera arrangement 904 is in communication with wearable display device 902 via a router 1002. In at least some embodiments, router 1002 is an optional component and camera arrangement 904 communicates directly with wearable display device 902.

Camera arrangement 904 transmits video and/or images to wearable display device 902 via router 1002. Responsive to receipt of video and/or images from camera arrangement 904, wireless display device 902, by way of processor 402 controlling display 404 (FIG. 4), displays the received video and/or images on the display. After the received video and/or images are displayed on display 404, the received video and/or images are pre-processed via image pre-processing 1006 by processor 402, e.g., contrast enhancement, etc.

In at least some embodiments, image pre-processing 1006 is performed prior to display of the received images and/or video on display 404. In at least some other embodiments, image pre-processing 1006 is performed simultaneous with display of the received images and/or video. In at least one embodiment, instructions comprising image pre-processing 1006 are stored in memory 406 (FIG. 4). In at least some embodiments, the result of pre-processing 1006 is stored in memory 406.

Next, processor 402 executes a set of instructions comprising an augmented reality-based image recognition functionality 1008 in order to identify elements of the received video and/or images. In at least one embodiment, the augmented reality-based image recognition functionality 1008 is stored in memory 406 (FIG. 4) or stored in a remote server or other processing device. In at least some embodiments, the result of image recognition functionality 1008 is stored in memory 406, e.g., recognition data corresponding to recognized elements of the received video and/or images.

Next, processor 402 executes a set of instructions comprising an overlay functionality 1010 in order to overlay recognition data generated from image recognition functionality 1008 onto the received video and/or images and generate an overlaid version of the received video and/or images. In at least some embodiments, the generated video and/or images are stored in memory 406. The overlay may also be in the form of audio alerts, data-feeds or tickers.

In at least some embodiments, image recognition functionality 1008 may be executed prior to pre-processing 1006.

After the generated video and/or images are generated, wearable display device 902 transmits, via execution of transmission functionality 1012, the generated video and/or images to a remote personal computer (PC), wireless terminal, or other device with which wearable display device manager is in communication.

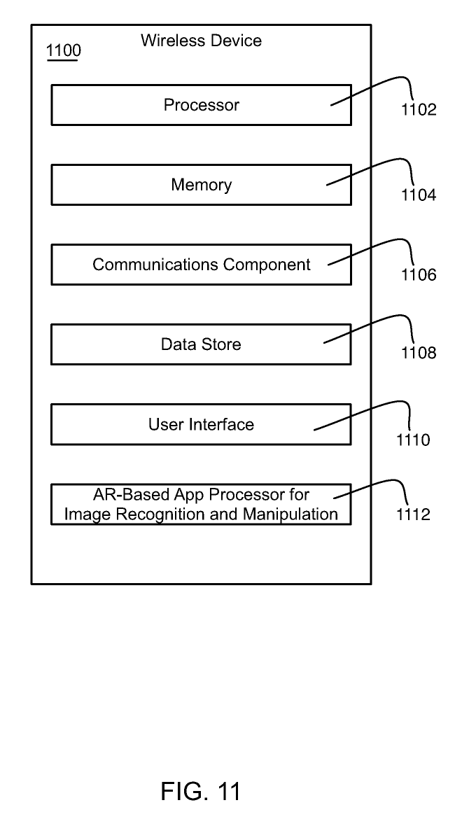

FIG. 11 is a high-level block diagram of components of a wireless wearable display device 1100 according to an embodiment. Display device 1100 comprises a processor 1102, a memory 1104, a communications component 1106, a data store 1108, a user interface 1110, and an augmented reality-based application processor for image recognition and manipulation 1112. In accordance with the FIG. 11 embodiment, the augmented reality-based functionality is implemented as a separate element of display device 1100. At least some embodiments, augmented reality-based functionality is implemented as a set of instructions stored in memory 1104.

FIG. 11 is a view of a wireless wearable display device according to an embodiment and comprising various modules that might be integrated into the wireless wearable display device, as described above.

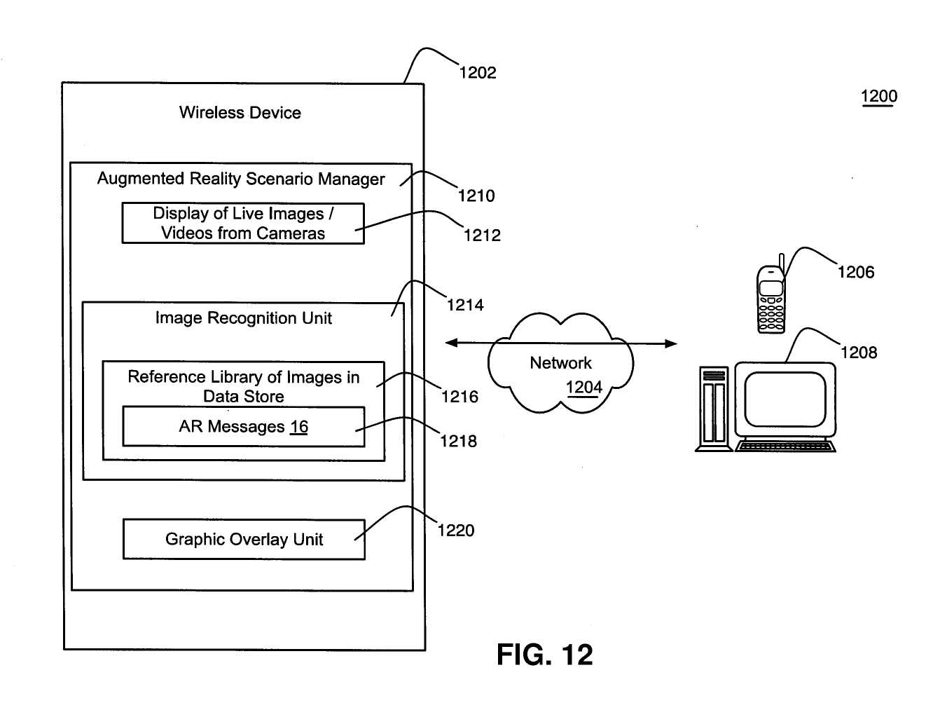

FIG. 12 is a high-level functional block diagram of at least a portion of a wearable display device 1202 according to another embodiment communicating via a network 1204 with a telephone 1206, e.g., a cellular phone, and/or a computer system 1208, e.g., a remote terminal, server, personal computer, or other processing device. Display device 1202 is similar to wearable display device 400 (FIG. 4). Display device 1202 comprises a set of instructions for execution by processor which comprise an augmented reality scenario manager 1210 stored in memory. The scenario manager performs a number of functions, including which video frames to process (i.e., no processing is necessary if the scenarios in the consecutive frames are almost identical, e.g., in some embodiments, consecutive frames comprise greater than 90% identical content; in other embodiments, consecutive identical frames comprise greater than 80% identical content; in still other embodiments, different percentages may be used to determine identical consecutive frames), whether to perform pre-processing of the entire frame or to search for certain elements in the frame (i.e., such as a license plate of a car, a child of certain description), when to overlay the results of augmented reality (AR)-based image matching on the actual images (i.e., only in the cases of a significant match), what medium to use to provide the results of AR-based processing to the user, etc.

Augmented reality scenario manager 1210 comprises a set of instructions for causing a display of live images and/or video received from one or more wireless cameras connected to the display device as described above. Scenario manager 1210 also comprises a set of instructions comprising an image recognition unit 1214 for attempting to recognize one or more elements from the received images and/or video. Image recognition unit 1214 comprises a reference library 1216 which stores images used during execution of image recognition unit 1214. Image recognition unit 1214 rather comprises a set of augmented reality messages 1218 for use in conjunction with library 1216 in order to generate alerts and/or messages responsive to recognition of one or more images by the image recognition unit.

Scenario manager 1210 also comprises a set of instructions comprising a graphic overlay unit 1220 for performing an overlay of one or more messages 1218 on the received images and/or video.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A glove having a display device, comprising:
a glove;
a display device mounted on the glove, the display device comprising:
a controller;
a display coupled with the controller; and
an input/output (I/O) device coupled with the controller and arranged to be coupled with a wireless camera; and
wherein the controller is arranged to receive an image from the I/O device and cause the display to display the received image.

2. The glove as claimed in claim 1, wherein the controller is arranged to display the received image overlaid with the results of an augmented-reality based image processing function.

3. The glove as claimed in claim 1, wherein the controller is arranged to display the received image overlaid with the results of an augmented-reality based image processing function, in the form of text, image, animations, video, sound, tickers or a combination thereof.

4. The glove as claimed in claim 1, wherein the display device is positioned on a sleeve portion of the glove adjacent an opening of the glove.

5. The glove as claimed in claim 1, wherein the I/O device is arranged to communicate wirelessly using a protocol selected from the group comprising at least one of Bluetooth or WiFi.

6. The glove as claimed in claim 1, wherein the controller is arranged to receive user commands via the glove and to cause transmission of the commands via the I/O device.

7. The glove as claimed in claim 4, wherein the controller is arranged to receive user commands via at least one of user manipulation of the display or user gestures.

8. The glove as claimed in claim 1, the display device further comprising an antenna coupled with the controller.

9. The glove as claimed in claim 1, wherein the I/O device comprises an antenna.

10. A glove system comprising:
a glove having a display device, the glove comprising:
a glove;
a display device connected with the glove, the display device comprising:
a controller;
a display coupled with the controller; and
an input/output (I/O) device coupled with the controller and arranged to be coupled with a camera; and
wherein the controller is arranged to receive an image from the I/O device and cause the display to display the received image.

11. The glove as claimed in claim 10, wherein the camera is coupled with the glove system.

12. The glove as claimed in claim 10, wherein the camera is a wireless camera.

13. The glove as claimed in claim 10, wherein the camera is arranged to communicate wirelessly with the I/O device.

14. The glove as claimed in claim 10, the display device further comprising an antenna coupled with the controller.

15. The glove as claimed in claim 10, wherein the I/O device comprises an antenna.

16. The glove as claimed in claim 10 wherein the glove is a wrist-band.

17. The glove as claimed in claim 10, wherein the display is mountable to a flexible material.

18. A vehicular-based system comprising one or more wireless cameras arranged to communicate with one or more wireless display-based garments, the garment comprising a display device connected with the garment, the display device comprising:
a controller;
a display coupled with the controller;
an input/output (I/O) device coupled with the controller and arranged to be coupled with at least one of the one or more wireless cameras; and
wherein the controller is arranged to cause the display to display a received image from the I/O device.

19. The system as claimed in claim 18 wherein the garment comprises at least one of a glove or a wristband.

20. The system as claimed in claim 18, wherein at least one of the wireless cameras is coupled with the display device.

21. The system as claimed in claim 18, wherein the vehicular-based system comprises two garments, each garment in the form of a glove.

22. The system as claimed in claim 18, wherein the vehicular-based system comprises at least two wireless cameras, each wireless camera coupled with a corresponding display device.
